(19) United States
(12) Patent Application Publication
(10) Pub. No.: US 2018/0194324 A1
(43) Pub. Date: Jul. 12, 2018

(54) METHOD TO OPERATE A MOTOR VEHICLE WITH A PORTABLE CONTROL DEVICE

(71) Applicant: FORD GLOBAL TECHNOLOGIES, LLC, Dearborn, MI (US)

(72) Inventors: Georg NEUGEBAUER, Herzogenrath (DE); Uwe GUSSEN, Huertgenwald (DE); Erik ALPMAN, Achen (DE); Kai SKOLIK, Wuerselen, NRW (DE)

(73) Assignee: FORD GLOBAL TECHNOLOGIES, LLC, Dearborn, MI (US)

(21) Appl. No.: 15/852,538

(22) Filed: Dec. 22, 2017

(30) Foreign Application Priority Data
Jan. 9, 2017 (DE) 10 2017 200 192.5

(51) Int. Cl. B60R 25/24; H04W 12/06; G06F 21/33; B62D 15/02; H04L 29/06; B60R 25/04

(52) U.S. Cl. CPC B60R 25/241; H04W 12/06; G06F 21/33; B60R 2325/205; H04L 63/0823; B60R 25/04; H04L 2463/121; B62D 15/0285

(57) ABSTRACT

The disclosure relates to a method for operation of a motor vehicle with a portable control device. The portable control device is designed to generate control signals to control the motor vehicle. The portable device is also designed to transmit the control signals to the motor vehicle. For authentication, a server generates a token, the token is transmitted to the portable control device, and the token, which is stored temporarily on the portable control device, is transmitted to, and verified by the motor vehicle.

### CROSS-REFERENCE TO RELATED APPLICATIONS

This application claims foreign priority benefits under 35 U.S.C. § 119(a)-(d) to DE Application 10 2017 200 192.5 filed Jan. 9, 2017, which is hereby incorporated by reference in its entirety.

### TECHNICAL FIELD

The disclosure relates to a method for the operation of a motor vehicle with a portable control device.

### BACKGROUND

Portable control devices, such as for example smartphones and tablets, can be designed to control a motor vehicle, for example in order to carry out a parking procedure, wherein the motor vehicle driver is located at the time outside the motor vehicle, and the motor vehicle is controlled through the input device. An input of control commands can take place here through a touchscreen of the portable control device.

For this purpose, however, an authentication of the driver in relation to the motor vehicle is necessary in order, for example, to prevent misuse such as, for example, a motor vehicle theft, and to ensure that only the driver can control the motor vehicle and not, for example, an underage, unauthorized person.

The authentication takes place in the course of an online authentication protocol between the driver and a server that is connected through the Internet, which verifies user-specific data such as, for example, usernames and/or passwords. This, however, requires an online connection between the portable control device and the server. In a region without cell phone network coverage, however, it can be impossible to establish an online connection with the server.

1 here is therefore a need to demonstrate ways in which an authentication of this sort can be arranged more reliably.

### SUMMARY

The object of the disclosure is achieved by a method for the operation of a motor vehicle with a portable control device, wherein the portable control device is designed to generate control signals to control the motor vehicle, and transmit them to the motor vehicle, wherein the following steps are carried out for authentication:

a server generates a token,

the token is transmitted to the portable control device,

the token, which is stored temporarily on the portable control device, is transmitted to the motor vehicle and verified by the motor vehicle.

The server can be a computer program or a computer that makes computer functionalities such as utility programs, data or other resources available, so that other computers or programs (“clients”), in this case the motor vehicle and the portable control device, can access them.

The token (also known as the security token or electronic key) serves for authentication of the driver. The token can be personalized, so that it can be uniquely assigned to a specific driver.

The token on the portable control device is here temporarily stored after its transmission to the portable control device, i.e. is archived there. A period of time of indeterminate length thus lies between the generation, transmission and temporary storage on the one side and the transmission of the temporarily stored token to the motor vehicle and verification of the temporarily stored token using, for example, a token copy that has also been temporarily stored. In other words, the disclosure proposes that a stock of tokens is generated in advance in order to be able to make use of them when needed. An authentication can thus take place even when an online connection is not present, and an authentication can thus be altogether more reliably designed.

According to one form of embodiment, the token is transmitted to the portable control device and to the motor vehicle when an online connection is present. A check is thus first made as to whether an online connection is present, for example a connection for wireless data transmission, in order to transfer data reciprocally between the server on the one hand and the motor vehicle as well as the portable control device on the other hand. When a connection of this sort is present, i.e. the motor vehicle and the portable control device are located in a region with cell phone network coverage in which it is possible to establish such a connection, the transmission of the token to the portable control device and, if relevant, a transmission of a token copy to the motor vehicle, takes place.

According to a further form of embodiment, the token which is temporarily stored on the portable control device is transmitted to the motor vehicle and verified by the motor vehicle when an online connection is not present. In other words, a check is first made as to whether an establishment of an online connection to the motor vehicle and to the portable control device is possible. If such a connection can be established, there is no necessity to make use of the temporarily stored token. The temporarily stored token is thus only accessed when no other form of authentication is possible.

According to a further form of embodiment, a token with a timestamp is used. The timestamp indicates a maximum period of validity of the token, for example in that it comprises its date of generation, with which it is then possible, together with a maximum period of generation, for an expiry date to be determined, or the timestamp directly indicates the expiry date. The security can thus be increased again.

In addition, successful and/or failed authentications making use of the token can be stored on the motor vehicle, for example in a log file, which permits the detection of a misuse.

A motor vehicle, a portable control device and a server, as well as computer program products for the operation of these components, also belong to the disclosure.

The disclosure will now be explained with reference to the drawings.

### BRIEF DESCRIPTION OF THE DRAWINGS

FIG. 1 shows schematically a motor vehicle, a portable control device and a server, as well as their components.

FIG. 2 shows schematically a flow diagram of a method for the operation of a motor vehicle with a portable control device.

### DETAILED DESCRIPTION

As required, detailed embodiments of the present disclosure are disclosed herein; however, it is to be understood that the disclosed embodiments are merely exemplary of the disclosure that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present disclosure.

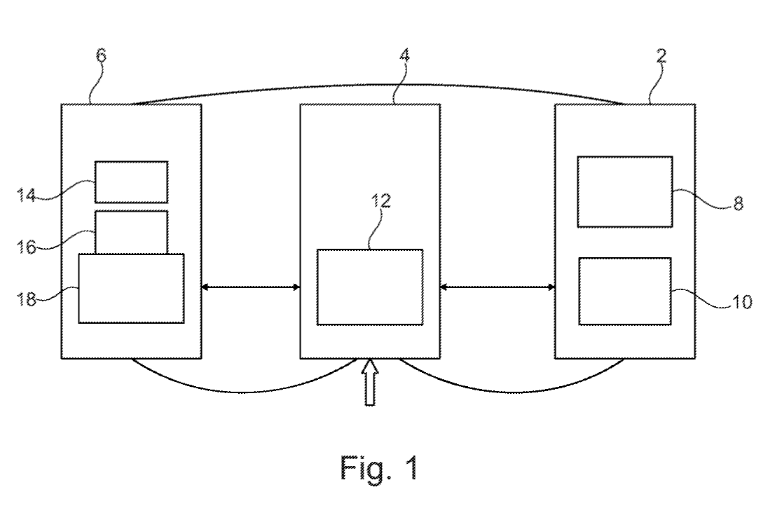

Reference is first made to FIG. 1.

A motor vehicle 2, such as for example an automobile, a portable control device 4 and a server 6 are illustrated.

In the present exemplary embodiment, the portable control device 4 is a handheld unit such as, for example, a smartphone or tablet. A handheld unit or handheld device refers to a portable, electronic device powered by accumulators or batteries for various applications. It is small and light enough that it can be held in only one hand when used, and is therefore referred to as handheld. Such a handheld unit can, for example, be a smartphone or a tablet. A smartphone here refers to a cell phone that makes substantially more comprehensive computer functionalities and connectivity available than a conventional “plain” cell phone. Touchscreens, i.e. touch sensitive screens, are a central feature of modern smartphones. The ability to install additional programs in a simple manner from Internet download pages, which have now become available for a large number of different purposes, is also an important feature. A tablet (from the US-English for a notepad) or tablet computer, tablet PC, occasionally also known as a flat computer, refers to a portable, flat computer of particularly lightweight construction with a touchscreen. Tablets are characterized by easy use as a result of the lightweight construction and the touch-sensitive screen. The devices are similar in scope of performance, operation and design to smartphones, and mostly use operating systems originally developed for smartphones. The scope of a tablet's functions can also be extended through additional programs (known as apps, short for applications).

The portable control device 4 is designed to generate control signals for control of the motor vehicle 2, and to transmit them to the motor vehicle 2. With the help of the portable control device 4, a driver of the motor vehicle 2 can thus control the motor vehicle 2 in order, for example, to carry out a parking maneuver during which the motor vehicle driver is not located in the motor vehicle 2.

For this purpose, the programming of the portable control device 4 is configured to read in inputs of the motor vehicle driver at, for example, a touchscreen, and to convert them into control signals that are transmitted over a wireless data connection from the portable control device 4 to the motor vehicle 2. The motor vehicle 2 is here designed, on receipt of control signals, to execute movements assigned to them, in that it carries out corresponding steering, acceleration and/or braking procedures.

In the present exemplary embodiment, the server 6 is a computer program or computer that makes computer functionalities such as utility programs, data or other resources available, which the motor vehicle 2 and the portable control device 4 can access.

In the present exemplary embodiment, the motor vehicle 2 comprises a verification module 8 and an authentication module 10.

In the present exemplary embodiment, the portable control device 4 comprises an authentication module 12.

In the present exemplary embodiment, the server 6 comprises a memory 14, a token generator 16 and an authentication module 18.

In operation, the motor vehicle 2, the portable control device 4 and the server 6 can exchange data over connections, each of which is wireless in the present exemplary embodiment, as explained later in more detail. A Bluetooth or WLAN connection can, for example, be used for the data transmission between the motor vehicle 2 and the portable control device 4, while a 3G, a 4G, or LTE connection can be used for the data transmission between the portable control device 4 and the server 6. The online connection between the motor vehicle 2 and the server 6 can here be of an indirect nature, i.e. data is first transmitted from the motor vehicle 2 to the portable control device 4, and then to the server 6, and vice versa.

The token generator 16 is designed to generate a token with a timestamp and to transmit the token to the portable input device 4 and to transmit a token copy to the motor vehicle 2, where they are respectively temporarily stored or archived, for example in the respective authentication modules 10, 12.

The portable control device 4 is designed, in response to a request from the driver's side, for example, to transmit the token that is temporarily stored in the authentication module 12 to the motor vehicle 2, and to compare the token with the token copy in the verification module 8. When the comparison shows that the token and the token copy are identical, the authentication module 8 issues a clearance, meaning that on receipt of control signals, which the driver enters by means of the portable control device 4, the motor vehicle 2 carries out the movements assigned to these control signals.

The motor vehicle 2 with its verification module 8 and authentication module 12, the portable control device 4 with its authentication module 10 and the server 6 with a memory 14, token generator 16 and authentication module 18 can each comprise hardware and/or software components in order to be able to perform these tasks and tasks described below.

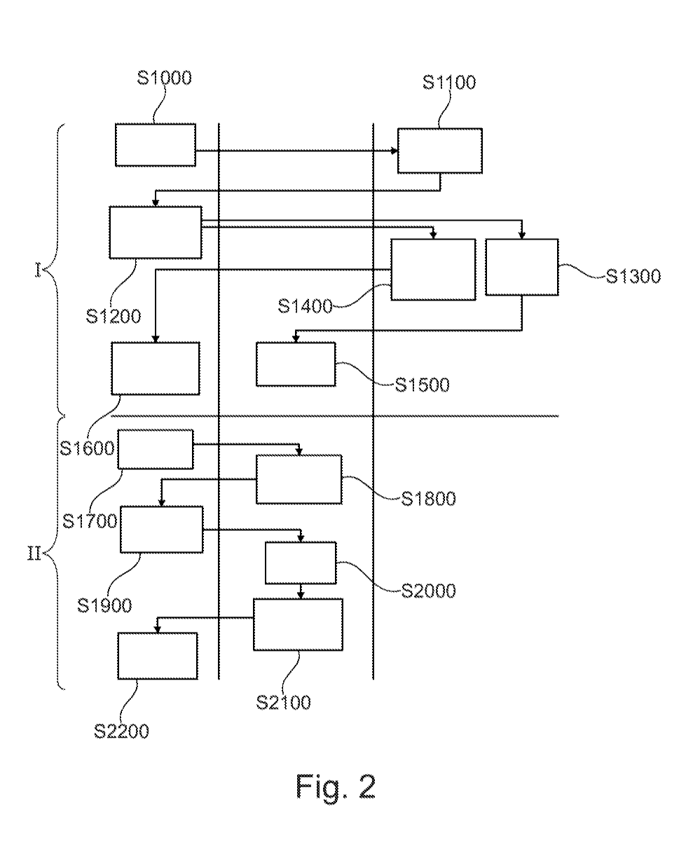

Reference is now also made to FIG. 2.

A method for the operation of the motor vehicle 2 with the portable control device 4 starts with an authentication which, in the present exemplary embodiment, includes a first phase I with the steps S1000 to 1600, and a second phase II with the steps S1700 to S2220.

The steps S1000 to S1600 of the first phase I are executed when an online connection for the exchange of data between the motor vehicle 2, the portable control device 4 and the server 6 can be established, while the steps S1700 to S2200 of the second phase II are executed when no online connection for the exchange of data between the motor vehicle 2, the portable control device 4 and the server 6 can be established.

In the first step S1000, data for authentication is transferred from the portable control device 4 to the server 6.

In the further step S1100 a verification of the authentication takes place on the server 6, for example through a comparison with datasets stored in the memory 14 by its authentication module 18.

In the further step S1200 a request for the generation and transfer of a token is transmitted from the portable control device 4 to the server 6.

In the further step S1300, the token is generated by the token generator 16. Furthermore a token copy and/or other data suitable for verification is generated in a further step S1400.

In the further step S1500, the token is temporarily stored in the portable control device 4, and in a further step S1600 the token copy and/or other data suitable for verification is temporarily stored in the motor vehicle 2.

The steps S1000 to S1600 are executed when an online connection for the exchange of data between the motor vehicle 2, the portable control device 4 and the server 6 can be established.

The following steps S1700 to S2200 are, in contrast, executed when no such online connection is present, i.e. when the motor vehicle 2 and the portable control device 4 are located in a region without cell phone network coverage in which, for example, no 3G or 4G network is available

In a further step S1700, a driver of the motor vehicle 2 starts, for example, a parking procedure with the mobile control device 4.

In response, the motor vehicle 2 transmits an authentication request to the portable control device 4 in a further step S1800.

On receipt of the authentication request, the portable control device 4 transmits the temporarily stored token with the timestamp to the motor vehicle 2 in a step S1900.

On receipt of the token with the timestamp, the motor vehicle 2, in a further step S2000, first checks the timestamp i.e. whether the transmitted token is still valid, and in a further step S2100 the motor vehicle 2 verifies the token itself, for example through a comparison with the token copy and/or of the other data suitable for verification.

If the token is still valid and, in addition, the comparison shows that the token and the token copy are identical, a confirmation is generated and transmitted to the portable control device 4, so that in a further step S2200, an authentication can be concluded and the actual parking procedure can start.

The sequence of the steps can here deviate from the present exemplary embodiment; for example, the sequence of the steps S1300 and S1400 can be a different one, or these steps can be executed simultaneously.

It can further be provided that successful and/or failed authentications making use of the token, i.e. during an authentication without cell phone network coverage, are stored in a log file on the motor vehicle 2. This stored data can be used to register a misuse, in that tokens are compared with their respective token copies.

An authentication can thus take place even when an online connection is not present, and an authentication can thus be altogether more reliably designed.

While exemplary embodiments are described above, it is not intended that these embodiments describe all possible forms of the disclosure. Rather, the words used in the specification are words of description rather than limitation, and it is understood that various changes may be made without departing from the spirit and scope of the disclosure. Additionally, the features of various implementing embodiments may be combined to form further embodiments of the disclosure.

What is claimed is:

1. A method to operate a vehicle, comprising:
generating control signals to control the vehicle with a portable control device;
transmitting the control signals to the vehicle; and
authenticating the control signal by verifying a token sent to the vehicle from the portable control device matches a copy of the token stored to the vehicle, the token having been generated by a server and sent from the server to the portable control device and the vehicle.

2. The method as claimed in claim 1, wherein transmitting the token to the portable control device and vehicle occurs when an online connection is present.

3. The method as claimed in claim 1, further comprising verifying the token temporarily stored on the portable control device when an online connection is not present.

4. The method as claimed in claim 1 further comprising timestamping the token.

5. The method as claimed in claim 1 further comprising storing successful or failed authentications using the token on the vehicle.

6. A vehicle comprising:
a portable control device configured to generate control signals and transmit the control signals to the vehicle; and
a verification module configured to, in response to a token being generated by a server, transmit the token to the portable control device, and, in response to the control signals, verify the token being stored temporarily on the portable control device with a copy of the token stored to the vehicle.

7. The vehicle as claimed in claim 6, wherein the verification module is configured to transmit the token to the portable control device and vehicle when an online connection is present.

8. The vehicle as claimed in claim 6, wherein the verification module is further configured to verify the token, temporarily stored on the portable control device, with the copy of the token stored to the vehicle when an online connection is not present.

9. The vehicle as claimed in claim 6, wherein the verification module is further configured to timestamp the token.

10. The vehicle as claimed in claim 9, wherein the verification module is further configured to verify the timestamp.

11. The vehicle as claimed in claim 6, wherein the verification module is further configured to store successful or failed authentications using the token on the vehicle.

12. A park assist system for a vehicle comprising:
an authentication module configured to, in response to a token being generated by a server, transmit the token to a portable control device to store the token temporarily and transmit the token to a vehicle, and, in response to control signals that execute movements of the vehicle, verify the token stored on the portable control device with the token stored to the vehicle before executing the movements.

13. The authentication module as claimed in claim 12, wherein the authentication module is configured to transmit the token to the portable control device and vehicle when an online connection is present.

14. The authentication module as claimed in claim 12, wherein the authentication module is further configured to verify the token, temporarily stored on the portable control device, with the vehicle when an online connection is not present.

15. The authentication module as claimed in claim 12, wherein the authentication module is further configured to timestamp the token.

16. The authentication module as claimed in claim 15, wherein the authentication module is further configured to verify the timestamp.

17. The authentication module as claimed in claim 12, wherein the authentication module is further configured to store successful or failed authentications using the token on the vehicle.
